(19) United States
(12) Patent Application Publication
(10) Pub. No.: US 2006/0231322 A1
(43) Pub. Date: Oct. 19, 2006

(54) Vehicle with a Drive Shaft Passing Through an Engine

(75) Inventors: Vincent Morin, Sherbrooke (CA); Mihai Rasidescu, Sherbrooke (CA)

Correspondence Address: OSLER, HOSKIN & HARCOURT LLP (BRP), 2100 - 1000 DE LA GAUCHETIERE ST. WEST, MONTREAL, H3B4W5, CA

(73) Assignee: Bombardier Recreational Products Inc., Valcourt (CA)

(21) Appl. No.: 11/278,256

(22) Filed: Mar. 31, 2006

Related U.S. Application Data
(60) Provisional application No. 60/668,100, filed on Apr. 5, 2005.

(51) Int. Cl. B60K 17/00

(52) U.S. Cl. 180/337; 180/908

(57) ABSTRACT

A vehicle has a transmission detachably connected to an engine casing. The engine crankshaft includes a drive pulley connected via a belt to a driven pulley in the transmission, thus providing a continuously variable transmission between the engine crankshaft and the transmission. The transmission is operatively connected to a rear drive shaft for delivering torque via a rear differential to the rear wheels and is selectively connected, for four-wheel-drive traction, to a front drive shaft which delivers torque via a front differential to the front wheels. The front drive shaft passes through the engine casing, passing above the oil pan and between the crankshaft counterweights of a piston of the engine.

### CROSS-REFERENCE TO RELATED APPLICATIONS

This application claims priority from U.S. provisional application 60/668,100 filed on Apr. 4, 2005, the entirety of which is incorporated herein by reference.

### FIELD OF THE INVENTION

The present invention relates generally to a wheeled vehicle and, more particularly, to a drivetrain of a wheeled vehicle where the engine and transmission are distinct units.

### BACKGROUND OF THE INVENTION

All-terrain vehicles (ATVs) are designed to traverse rugged terrain. Accordingly, vehicle stability is one of the primary design considerations. As is well known in the art, vehicle stability can be improved by lowering and centralizing mass without unduly compromising ground clearance and ergonomics. Mass centralization can be improved by locating heavy components as close as possible to the geometrical center of the vehicle.

In the prior art, some ATV manufacturers (e.g. Polaris™, Yamaha™, and Kawasaki™) have developed drivetrains in which a transmission is separated from the engine. These have benefits in terms of assembly and maintenance. For example, U.S. Pat. No. 6,286,619 (Uchiyama et al.) discloses an ATV transmission in which a final drive assembly is mounted to a rear of the frame and is operatively connected to the engine via a belt or chain. This drivetrain design expedites assembly by obviating the need to install a fully assembled drivetrain (engine and transmission). Likewise, in U.S. Pat. No. 6,601,668 (Kitai et al.), a rear reduction gear case is mounted at the rear of the ATV and receives power from the engine via a rear propeller shaft.

However, since these prior-art drivetrains have a transmission mounted behind the engine, it is problematic to deliver power to the front differential and front wheels to achieve full four-wheel-drive traction.

Where a transmission is rearward of the engine casing, the conventional approach has been to route the drivetrain around the side of the engine casing or, alternatively, to route the drivetrain under the engine casing.

In the former case, routing the drivetrain around the side of the engine casing adds a number of extra components (intermediary shafts and gears). This design solution undesirably adds cost and weight, not to mention creating packaging problems, especially with respect to the footboards. This prior-art solution is also inefficient in terms of transmitting power as a greater number of joints are involved. Power transmission is also less efficient because of the meshing of angled gears needed to circumvent the engine. The increased number of rotating parts that are exposed to the environment also augments the amount of maintenance required to keep the drivetrain in proper running condition.

In the latter case, routing the drivetrain under the engine is undesirable as it elevates the center of gravity of the vehicle, thereby undermining the vehicle's handling and stability.

In light of the foregoing, there remains a need for a vehicle, and in particular an ATV, with a drivetrain that ameliorates at least one of the aforementioned deficiencies of the prior art.

### STATEMENT OF THE INVENTION

It is therefore an object of the present invention to provide a wheeled vehicle with a drivetrain that ameliorates at least one of the foregoing deficiencies. To overcome at least one of the foregoing deficiencies, a wheeled vehicle is provided with a drivetrain in which a drive shaft passes through an engine casing to deliver torque from a transmission on one side of the casing to a differential on the other side of the casing. The driveshaft could be one of a front and rear driveshaft which delivers torque to a corresponding one of a front and rear differential.

In accordance with an aspect of the present invention, a wheeled vehicle has a frame; a straddle seat mounted on the frame for supporting a driver; a plurality of wheels suspended from the frame, each wheel having a tire; a steering assembly disposed on the frame forwardly of the straddle seat for steering at least one of the plurality of wheels; an engine mounted to the frame, the engine having an engine casing and a crankshaft; a transmission being driven by the crankshaft, the transmission being disposed outside of the engine casing, a drive shaft passing through the engine casing, the drive shaft being driven by the transmission and being separate from the crankshaft; and a differential being driven by the drive shaft, the drive shaft driving at least one of the plurality of wheels via the differential and other conventional components.

For the sake of clarity, the expression “different unit” refers to an element being separate from other element, although they may be connected to each other. For example, in embodiments of the present invention, although the transmission can be connected from the engine casing, it does not form part of the engine casing, it is therefore a “different unit” from the engine casing. The term “engine casing” does not require that a casing separate from the engine be disposed about the engine. An “engine casing” is generally considered to be the outside portion of the engine containing the internal components of the engine, for example the crankcase and cylinder block which respectively contain the crankshaft and cylinders. A “drive shaft” means either a unitary shaft or a shaft constructed by a number of subshafts. Other constructions of driveshaft are also contemplated. Also, the expressions “driving” and “driven” refer to the action of transmitting power from one element to another, the “driving” element transmitting power to the “driven” element.

In accordance with another aspect of the present invention, a wheeled vehicle has a frame; a straddle seat mounted on the frame for supporting a driver; a plurality of wheels suspended from the frame, each wheel having a tire; a steering assembly disposed on the frame forwardly of the straddle seat for steering at least one of the plurality of wheels; an engine mounted to the frame, the engine having an engine casing and a crankshaft; means for transmitting power being driven by the crankshaft, the means for transmitting power being disposed outside of the engine casing; means for driving at least one of the wheels passing through the engine casing, the means for driving being driven by the means for transmitting power and being separate from the crankshaft; and a differential being driven by the means for driving, the means for driving driving at least one of the plurality of wheels via the differential.

In accordance with another aspect of the present invention, a wheeled vehicle has a frame; a straddle seat mounted on the frame for supporting a driver; a plurality of wheels suspended from the frame, each wheel having a tire; a steering assembly disposed on the frame forwardly of the straddle seat for steering at least one of the plurality of wheels; an engine mounted to the frame, the engine having an engine casing and a crankshaft; and a drivetrain. The drivetrain has a transmission operatively interconnecting the crankshaft with one of the wheels; and a plurality of shafts, at least one of the plurality of shafts passing through the engine.

In some embodiments, the transmission is disposed rearwardly of the engine casing, whereby a front drive shaft passes through the engine casing to deliver torque to the front wheels via a front differential. In other embodiments, the transmission is disposed forwardly of the engine casing, whereby a rear drive shaft passes through the engine casing to deliver torque to the rear wheels via a rear differential.

In embodiments of the present invention, the transmission is detachably connected to the engine casing. Where the transmission is disposed forwardly of the engine casing, then the transmission can be connected to the forward face of the engine casing. Conversely, where the transmission is disposed rearwardly of the engine casing, then the transmission can be connected to the rearward face of the engine casing.

In embodiments of the present invention, the drive shaft passes through the engine casing above an oil pan disposed at a bottom portion of the engine so that the drive shaft does not turn in the oil, which would result in power loss and undesirable heat transfer to the oil. The drive shaft could be disposed either above the oil in the oil pan or wholly beneath the oil pan in order to avoid contact with the oil.

In other embodiments, the drive shaft passes between a pair of crankshaft counterweights. Alternatively, the drive shaft passes to the side of the counterweights.

In embodiments of the present invention, a front drive shaft is parallel to a central longitudinal axis of the vehicle and perpendicular to the crankshaft. Preferably, the front drive shaft is co-axial with an input shaft of the front differential.

In yet a further embodiment, the front drive shaft, the front differential, a rear drive shaft and a rear differential are coaxial, defining an axis parallel to the central longitudinal axis of the vehicle.

By detachably connecting the transmission to a rear face of the engine casing and by routing the front drive shaft directly through the engine casing, the resulting drivetrain optimally lowers the center of gravity of the vehicle, thereby providing improved handling and stability.

Furthermore, with the drive shaft passing through the engine casing, the resulting drivetrain is compactly packaged, thereby minimizing space requirements. Because the drivetrain is compactly packaged, the vehicle can maintain an ergonomic width and properly spaced footboards can be easily accommodated.

Moreover, since the drive shaft passes through the engine casing, the engine can provide extra bearing support. This drivetrain layout also improves the ability to integrate the 2WD-4WD selector in the transmission. Furthermore, the drive shaft is protected from damage from off-road obstacles striking the underside of the vehicle. The drive shaft is also protected from the elements, thus reducing the likelihood of corrosion and obviating the need to provide extra corrosion-resistant coatings for the drive shaft.

In summary, therefore, the drivetrain has a front (or rear) drive shaft that passes through the engine casing from the transmission to the front (or rear) differential (as the case may be). The front drive shaft can include two (or more) subshafts, at least one of which traverses the engine casing. The front drive shaft preferably passes through the engine casing at the bottom of the engine casing, most preferably passing above the oil pan and between the counterweights.

Although the transmission is described as being mounted directly to the engine casing, it should be appreciated that the transmission could be mounted only to the frame rather than directly to the engine casing. In this arrangement, the engine casing and transmission are each independently mounted to the frame and are operatively connected by a belt-driven CVT.

Therefore, a vehicle in which the drive shaft passes through the engine casing provides benefits in terms of cost, packaging, weight, simplicity, and maintenance.

### BRIEF DESCRIPTION OF THE DRAWINGS

Further features and advantages of the present invention will become apparent from the following detailed description, taken in combination with the appended drawings, in which:

FIG. 1 is a perspective view, taken from a front left side, of an ATV incorporating embodiments of the present invention;

FIG. 2 is a schematic layout of an ATV drivetrain in accordance with the present invention;

FIG. 3 is a schematic layout of an ATV drivetrain in accordance with the present invention;

FIG. 4 is a side elevation view of an engine and transmission in accordance with the present invention;

FIG. 5 is a cross-sectional view of the front drive shaft traversing the engine casing in accordance with the present invention;

FIG. 6 is a front elevation view showing the front drive shaft passing above the oil pan of the engine and between the counterweights of the crankshaft in accordance with the present invention;

FIG. 7 is a schematic side view of the drivetrain in accordance with the present invention;

FIG. 8 is a perspective view of a bottom portion of the transmission in accordance with the present invention, showing a 2WD-4WD selector mechanism for selectively coupling the transmission to the front drive shaft in addition to the rear drive shaft;

FIG. 9 is schematic layout of an ATV drivetrain in accordance with the present invention in which the transmission is disposed forward of the engine casing; and

FIG. 10 is a schematic side view of an alternative drivetrain in accordance with the present invention.

It will be noted that throughout the appended drawings, like features are identified by like reference numerals.

### DETAILED DESCRIPTION OF THE PREFERRED EMBODIMENTS

The present invention is being described throughout this description as being used in an all-terrain vehicle, however it is contemplated that the invention could be used in other wheeled vehicles.

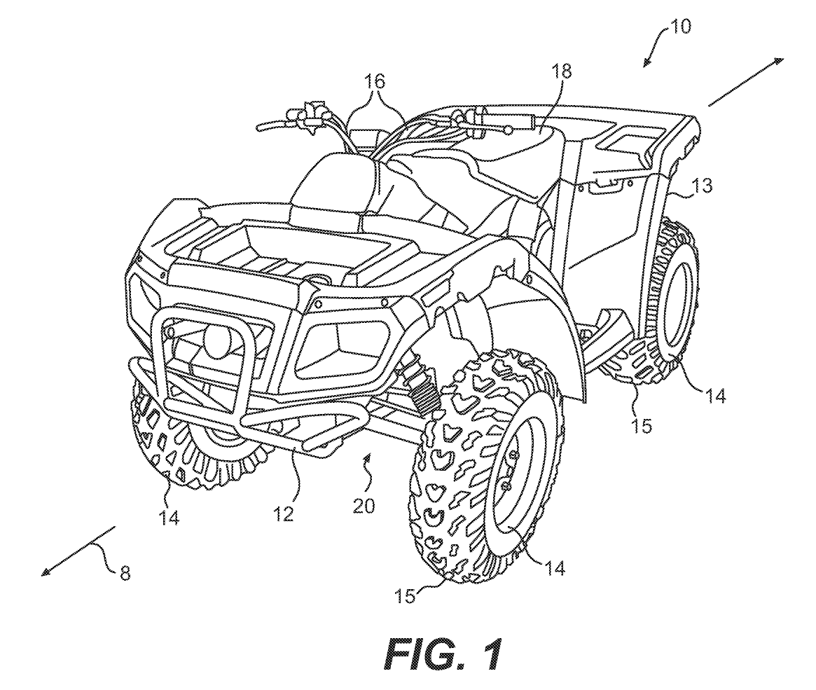

FIG. 1 is an perspective view of an all-terrain vehicle (ATV), generally designated by reference numeral 10, incorporating a drivetrain 20 in accordance with an embodiment of the present invention. The ATV 10 includes a frame 12 to which is mounted a body 13 and an internal combustion engine (not visible in FIG. 1) for powering the vehicle. Also connected to the frame 12 are four wheels 14 with low-pressure balloon tires 15 which are adapted for off-road conditions and traversing rugged terrain. The ATV 10 further includes a straddle seat 18 mounted to the frame 12 for supporting a driver and optionally one or more passengers. The ATV 10 has a center of gravity through which traverses a central longitudinal axis 8.

As shown in FIG. 1, two front wheels 14 are suspended from the frame 12 by respective front suspension assemblies (e.g. double A-arm suspension systems) while two rear wheels 14 are suspended from the frame by respective rear suspension assemblies (e.g., rigid swing arm suspension systems). The front and rear wheels 14 have 10 to 12 inch rims and are each disposed with a low-pressure balloon tire 15 that is mounted to a rim of each wheel and inflated to a pressure of no more than 2 kg/cm² (i.e., no more than 196 kPa or 28 psi).

Still referring to FIG. 1, the ATV 10 further includes a steering mechanism 16 which is rotationally supported by the frame 12 to enable a driver to steer the vehicle. The steering mechanism 16 includes handlebars connected to a steering column (not shown) for actuating steering linkages connected to left and right front drive assemblies.

As is known in the art, the ATV 10 is powered by an internal combustion engine having an engine casing 30, e.g. a 4-cycle single overhead cam engine whose cylinders are configured in a single or double V although, as will be readily appreciated by those of ordinary skill in the art, other types and configurations of engines can be substituted. The cylinders house reciprocating pistons 31 connected to a crankshaft 34, as is also well known in the art. The crankshaft 34 of the engine is coupled to a drivetrain 20 which delivers torque to the rear wheels 14, providing at least two-wheel-drive (2WD), and optionally also delivers torque to the front wheels 14 for four-wheel-drive (4WD) traction.

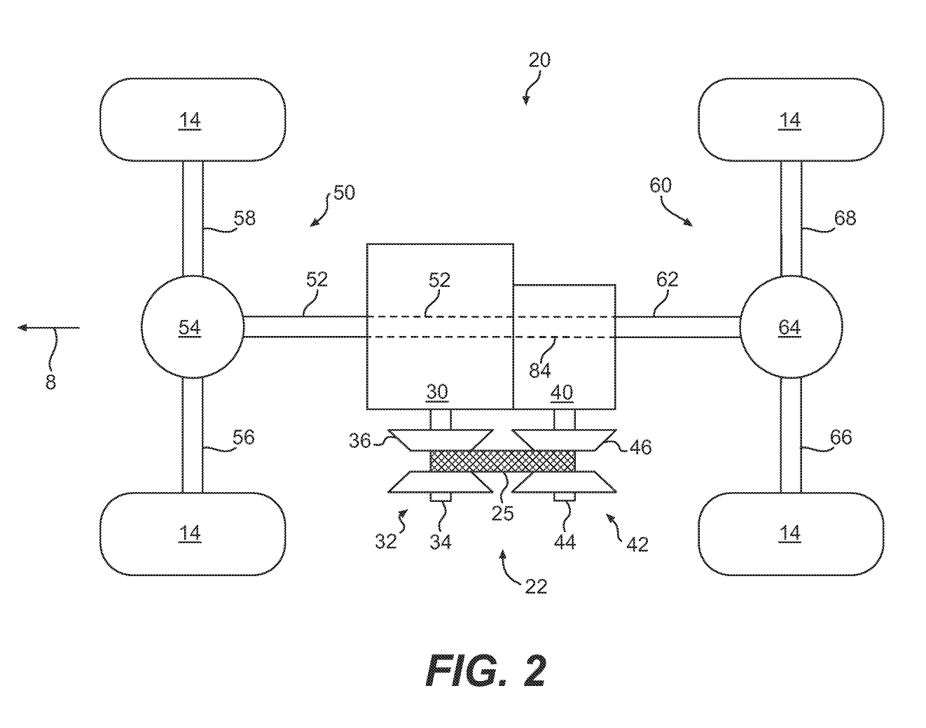

FIG. 2 illustrates schematically the layout and power pack of the drivetrain 20 in accordance with an embodiment of the present invention. As mentioned above, the drivetrain 20 is mechanically coupled to the internal combustion engine. In accordance with the preferred embodiment of the invention, the drivetrain 20 includes a distinct transmission 40 that is detachably connected to a rear portion of the engine casing 30. The transmission 40 is preferably connected to the engine casing 30 with threaded fasteners 70, e.g. bolts, which facilitate assembly and disassembly of the transmission 40.

As shown in FIG. 2, the engine and transmission 40 are operatively connected by a continuously variable transmission (CVT) 22 having a belt 25 connecting an engine output 32 to a transmission input 42. The engine output 32 includes a crankshaft 34 connected to and driven by the pistons 31 in the cylinders of the internal combustion engine. Mounted to the crankshaft 34 is a drive pulley 36 which drives a corresponding driven pulley 46 via the belt 25. The driven pulley 46 is mounted to an input shaft 44 which delivers power to the transmission 40. The transmission 40 has a gearbox (not shown, but well known in the art) to reduce the angular velocity of the input shaft 44 in favor of greater torque.

As shown in FIG. 2, the transmission 40 operatively connects to both a front drive system 50 and a rear drive system 60. The front drive system 50 includes a front drive shaft 52 connected at a rearward end to the transmission 40 (i.e. to a forward end of an intermediary shaft 84 of the transmission 40) and at a forward end to a front differential 54. The front differential 54 is connected to a left front axle 56 and a right front axle 58 which are, in turn, connected to the front wheels 14. Likewise, the rear drive system 60 includes a rear drive shaft 62 connected at a forward end to the transmission 40 (i.e. to a rearward end of the intermediary shaft 84 of the transmission 40) and at a rearward end to a rear differential 64. The rear differential 64 connects to a left rear axle 66 and a right rear axle 68 which are, in turn, connected to the rear wheels 14. Therefore, the drivetrain 20 allows the driver to select either two-wheel-drive (2WD) traction (i.e. power delivered only to the rear drive shaft) or four-wheel-drive (4WD) traction (i.e. power delivered to both the front and rear drive shafts).

In order to enable the driver to select between 2WD and 4WD modes, the transmission 40 includes, in the preferred embodiment, a 2WD-4WD selector capable of selectively engaging or disengaging a front-to-rear drive shaft coupling. This enables a driver to switch between 2WD and 4WD. The transmission 40 can also include a transmission selector to enable a driver to select one of a plurality of drive modes for the vehicle, the drive modes including park, neutral, reverse and drive. In one embodiment, the drive modes further include high-speed drive and low-speed drive. As will be appreciated by those of ordinary skill in the art, the transmission selector can enable selection of other drive modes, e.g. three or more forward drive speeds. The transmission selector is itself connected to a shifter (not shown) that is readily accessible by the driver thereby enabling the driver to actuate the transmission selector while comfortably seated in the driver seat.

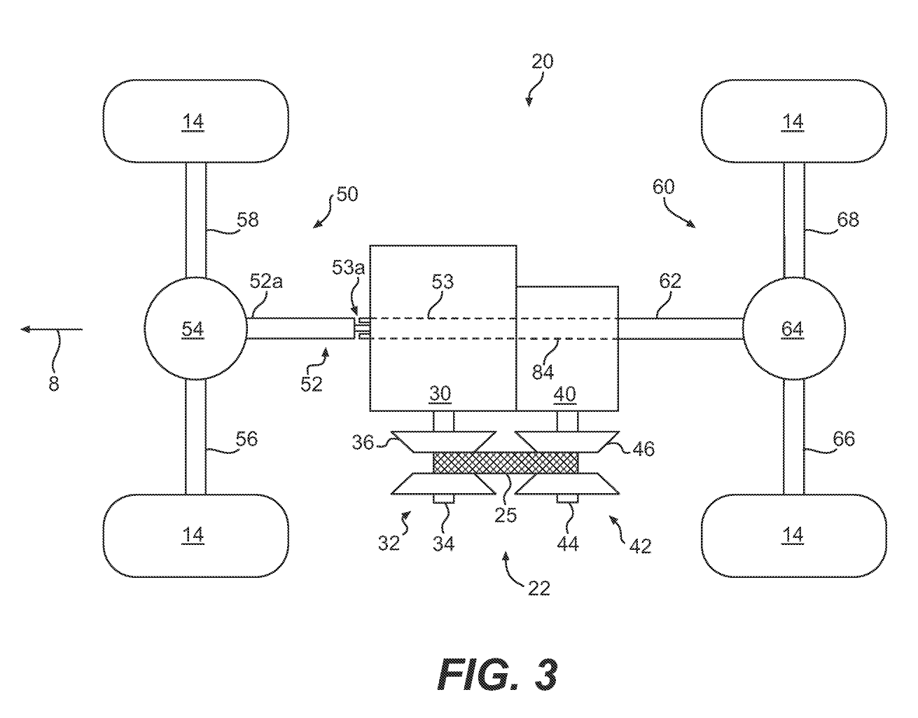

FIG. 3 shows the layout and power pack of the preferred embodiment of the drivetrain 20 in which the front drive shaft 52 is an articulated drive shaft having two subshafts 52a, 53 connected by a universal joint 53a. As shown in FIG. 3, a first subshaft 53 connects at a rearward end to the forward end of the intermediary shaft 84 and connects at a forward end to the rearward end of a second subshaft 52a via the universal joint 53a. Accordingly, the first subshaft 53 runs through the engine casing 30 while the second subshaft 52a runs from the universal joint 53a protruding from the engine casing 30 and terminates at the front differential 54. As will be appreciated by those of ordinary skill in the art, the drivetrain 20 could be modified to include additional subshafts.

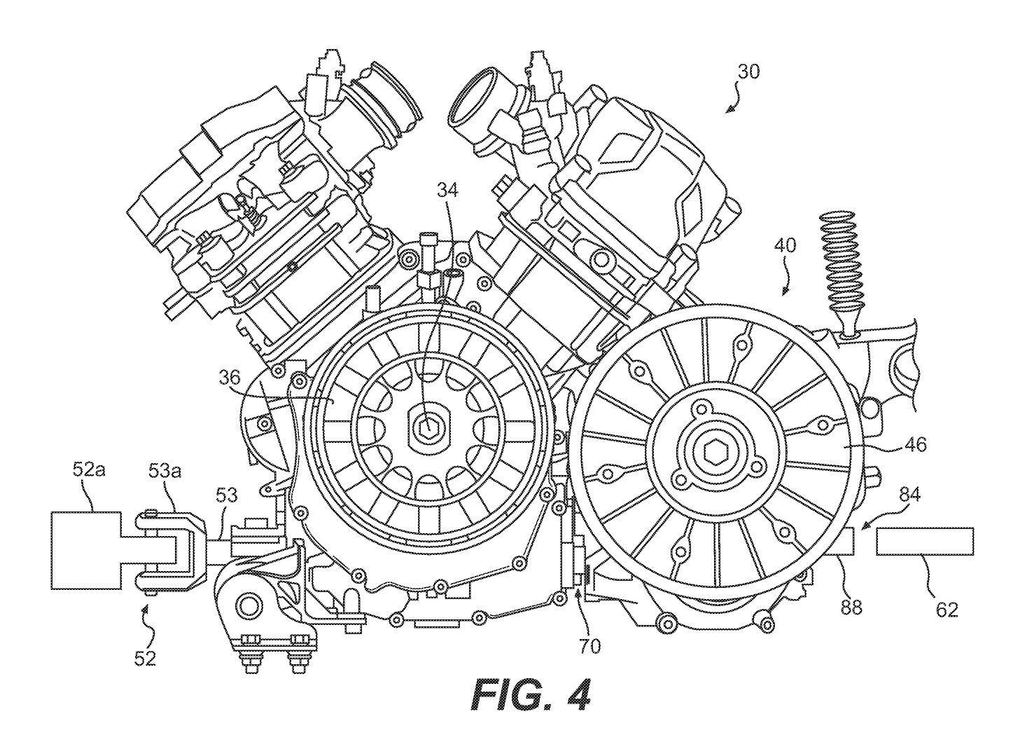

FIG. 4 is a side elevation view of the transmission 40 detachably connected by fasteners 70 to a rear face of the engine casing 30 in accordance with the preferred embodiment of the present invention. The engine and transmission 40 are operatively connected by a belt-driven CVT 22 which couples the drive pulley 36 on the crankshaft 34 to the driven pulley 46 on the input shaft 44 of the transmission 40. The drive pulley 36 and the driven pulley 46 permit a continuously variable transmission ratio by virtue of the opening or closing of opposed conical side faces of one or more of the pulleys, as is known in the art.

As shown in FIG. 4, the intermediary shaft 84 has a splined rearward end 88 that protrudes from the rear of the transmission 40 to mesh with complementary splines on a front end of the rear drive shaft 62.

As further illustrated in FIG. 4, the first subshaft 53 of the front drive shaft 52 passes through the engine casing 30 and protrudes from a forward face of the engine casing 30 to terminate in a universal joint 53a. The universal joint 53a rotationally connects the first subshaft 53 and the second subshaft 52a of the front drive shaft 52. In another embodiment, a single front drive shaft 52 passes through the engine casing 30 to deliver torque from the transmission 40 to the front differential 54 and to the front wheels 14. As shown in FIG. 4, the front drive shaft 52 (or the first subshaft 53 in the preferred embodiment) passes through a bottom portion of the engine casing 30, beneath the crankshaft 34 and above the oil pan 37, as will be described and illustrated below.

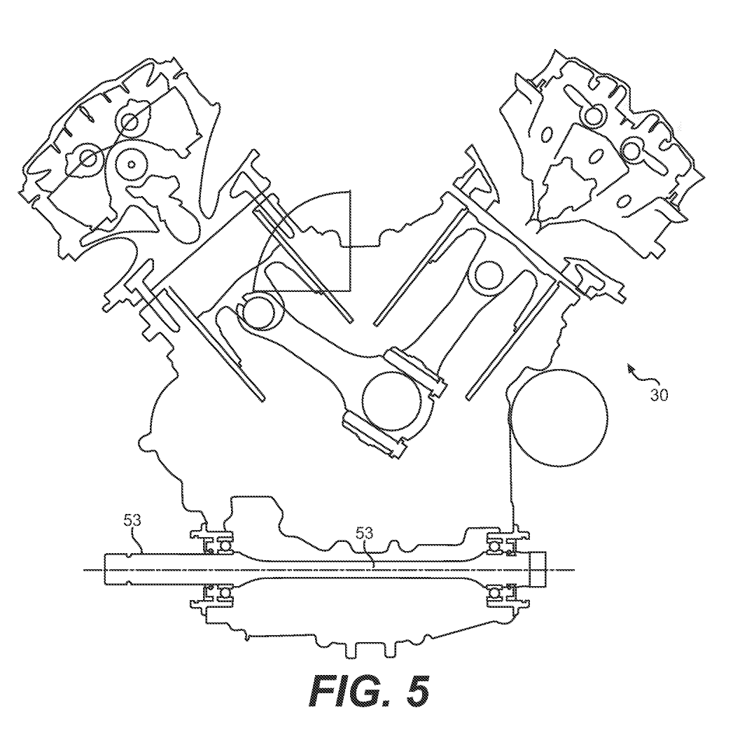

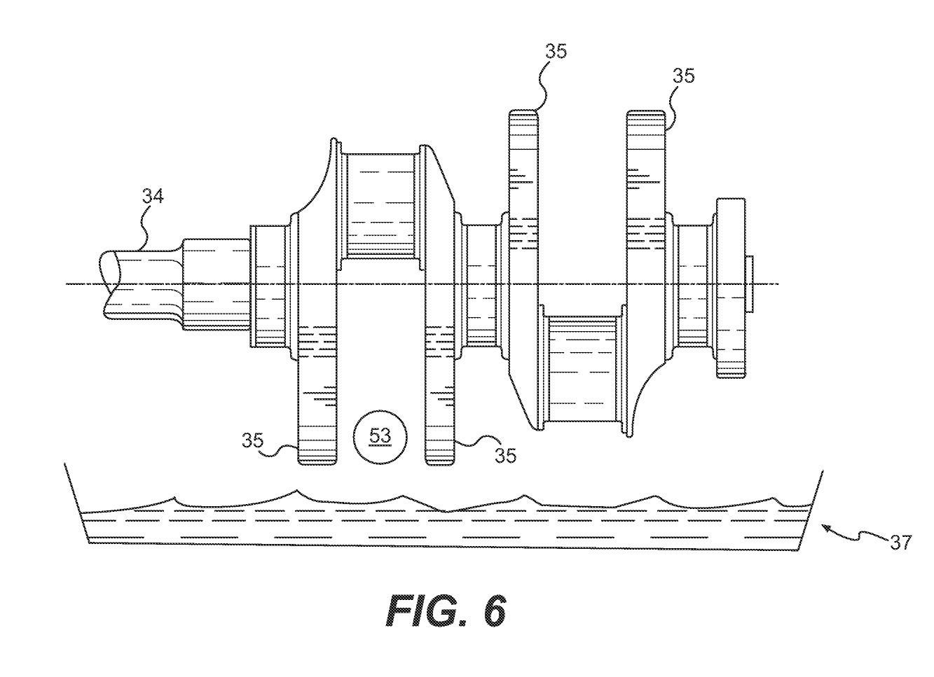

FIG. 5 is a cross-sectional view of the first subshaft 53 of the front drive shaft 52 passing through the engine casing 30. In the preferred embodiment, the first subshaft 53 of the front drive shaft 52 passes through the bottom portion of the engine casing 30. As shown in FIG. 6, the first subshaft 53 preferably passes through the engine casing 30 beneath the crankshaft 34 but above an oil pan 37. Preferably, the front drive shaft 52 (or first subshaft 53) should not contact the oil contained in the oil pan 37. The drive shaft 52 can also be made to pass beneath the oil pan 37 rather than above the oil level in the oil pan 37. In either design, the drive shaft 52 does not contact the oil.

Preferably, as illustrated in FIG. 6, the first subshaft 53 passes between adjacent counterweights 35. As will be appreciated by those of ordinary skill in the art, sufficient clearance must be provided between the first subshaft 53 and the crankshaft 34 so that when the piston bottoms out, the crankshaft 34 does not interfere with the first subshaft 53. Alternatively, where packaging and weight distribution are not hindered, the first subshaft 53 can be made to pass beside the counterweights 35 rather than passing between a pair of adjacent counterweights 35.

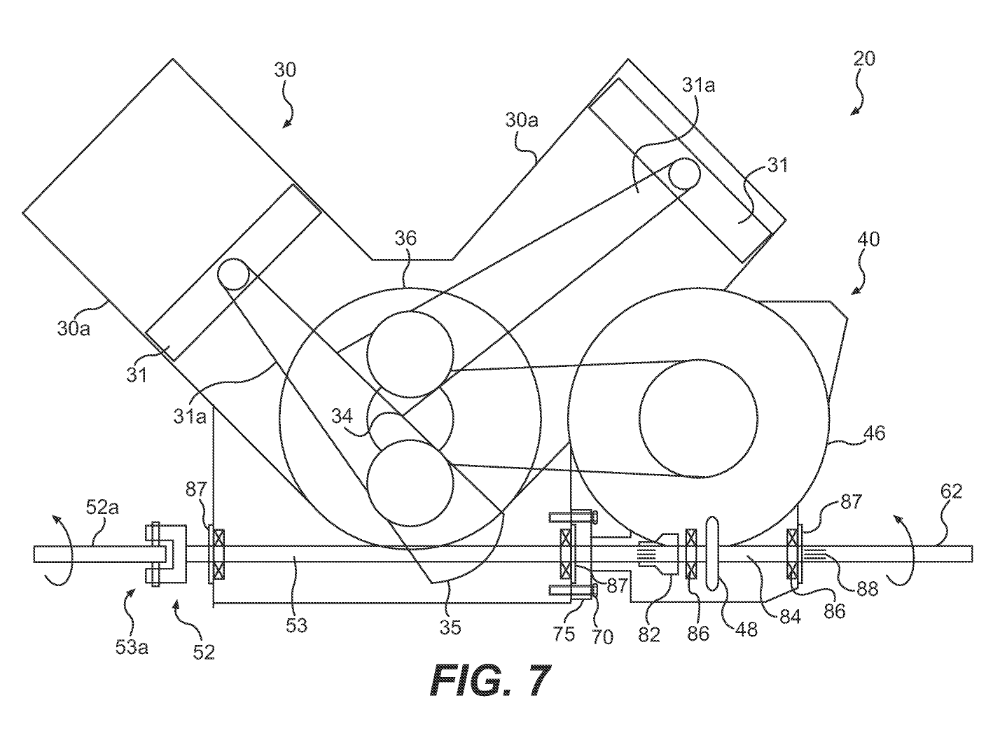

FIG. 7 is a schematic side view of the drivetrain 20 in accordance with the preferred embodiment of the present invention. As shown in FIG. 7, a V-type engine, having an engine casing 30, has a pair of cylinders 30a. Each cylinder 30a has a reciprocating piston 31 connected to a connecting rod (or piston rod) 31 a for turning respective cranks on the common crankshaft 34 as is well known in the art of internal combustion engines. The crankshaft 34 has two pairs of downwardly depending counterweights 35 (as was better illustrated in FIG. 6). Finally, as mentioned above, the drive pulley 36 is mounted to the crankshaft 34 for driving the driven pulley 46 via the belt-driven CVT 22.

As shown in FIG. 7, in the preferred embodiment, the transmission 40 is fastened to a rear lower portion of the engine casing 30 using a plurality of threaded fasteners 70, e.g. bolts or screws, which facilitate assembly and disassembly, i.e. expedites the attaching and detaching of the transmission 40 to and from the engine casing 30. By detachably connecting the transmission 40 to the rear of the engine casing 30, the center of gravity of the drivetrain 20 is lowered while also optimizing mass centralization.

As illustrated in FIG. 7, in the preferred embodiment, the transmission 40 has a forward-facing mounting flange 75 for engaging a rear surface of the engine casing 30. The mounting flange 75 includes a plurality of circumferentially spaced holes through which the threaded fasteners 70 are inserted. In the preferred embodiment, the engine casing 30 has a plurality of circumferentially spaced bores corresponding to the holes in the mounting flange 75. The bores in the engine casing 30 are drilled and tapped with threads corresponding to the threads of the fasteners 70. It should be noted that a further design consideration is to provide sufficient clearance between the engine casing 30 and the transmission 40 to access all of the fasteners with a wrench or other such tool. Optionally, washers may be provided to minimize localized stress where the fasteners 70 are tightened to a very high torque, as is known in the art. Also, as known in the art, a thread-locker such as Loctite™ may applied to further secure the threaded connections so as to prevent loosening of the threaded connections due to engine vibration.

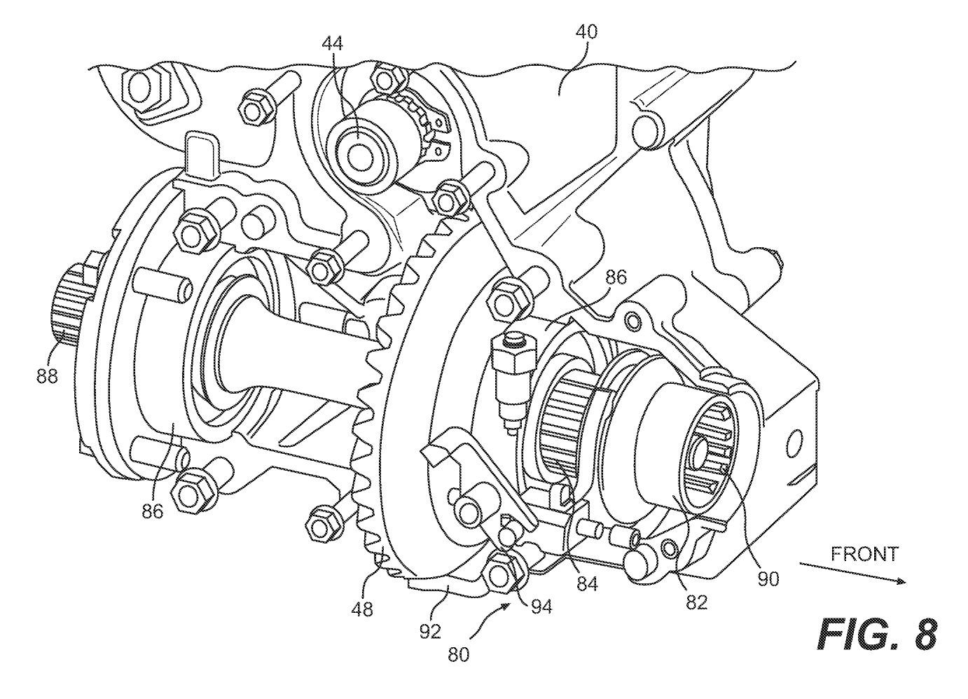

As further illustrated in FIGS. 7 and 8, the transmission 40 includes a reduction gear 48 securely mounted to the intermediary shaft 84. The intermediary shaft 84 is supported by and runs on a plurality of bearings 86 housed in bearing mounts. The rearward end of the intermediary shaft 84 has splines 88 to mesh with complementary splines in the rear drive shaft 62.

The forward end of the intermediary shaft 84 also has splines which selectively mesh with a 2WD-4WD selector coupling, e.g. a splined sleeve 82 which is axially actuated to couple power to the first subshaft 53. The first subshaft 53 preferably passes through a bore in the mounting flange 75. The first subshaft 53 passes through the engine casing 30, passing between the counterweights 35. The first subshaft 53 terminates in the universal joint 53a for connecting to the second subshaft 52a.

As further illustrated in FIG. 7, the engine and transmission 40 include annular grooves for receiving annular seals 87 for sealing the engine casing 30 and transmission 40 at the interfaces where the first subshaft 53 passes in order to prevent oil from leaking out of the engine casing 30 or transmission 40.

FIG. 8 shows a 2WD-4WD selector mechanism 80 which selectively axially displaces the splined sleeve 82 into meshed engagement with the splined intermediary shaft 84 to couple the front and rear drive shafts 52, 62. The sleeve 82 is displaced by pivoting a lever arm 92 about a pivot 94.

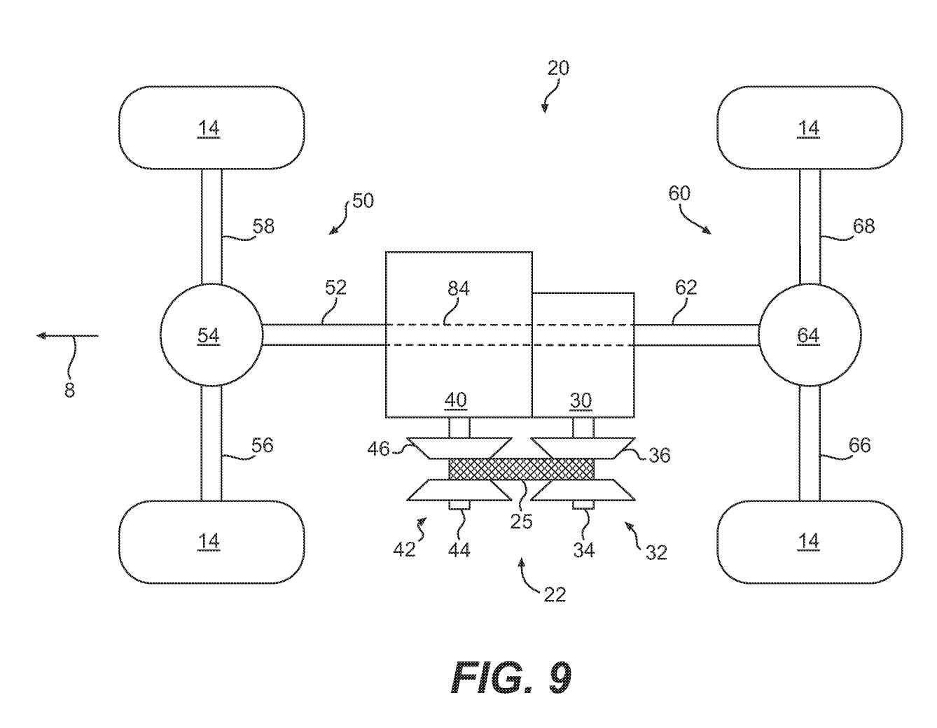

FIG. 9 is a schematic layout showing another embodiment in which the transmission 40 is disposed forward of the engine casing 30 (instead of rearward as in the preceding embodiments). For example, the transmission 40 may be disposed forward of the engine casing 30 for reasons of packaging or weight distribution. As shown in FIG. 9, the transmission 40 drives an intermediary shaft 84 which is coupled to both a front drive shaft 52 and a rear drive shaft 62. In this embodiment, the rear drive shaft 62 passes through the engine casing 30 to deliver torque to the rear differential 64. Preferably, the transmission 40 is mounted to the forward face of the engine casing 30. More preferably, the transmission 40 is fastened in the manner already described with respect to the rear-mounted embodiments.

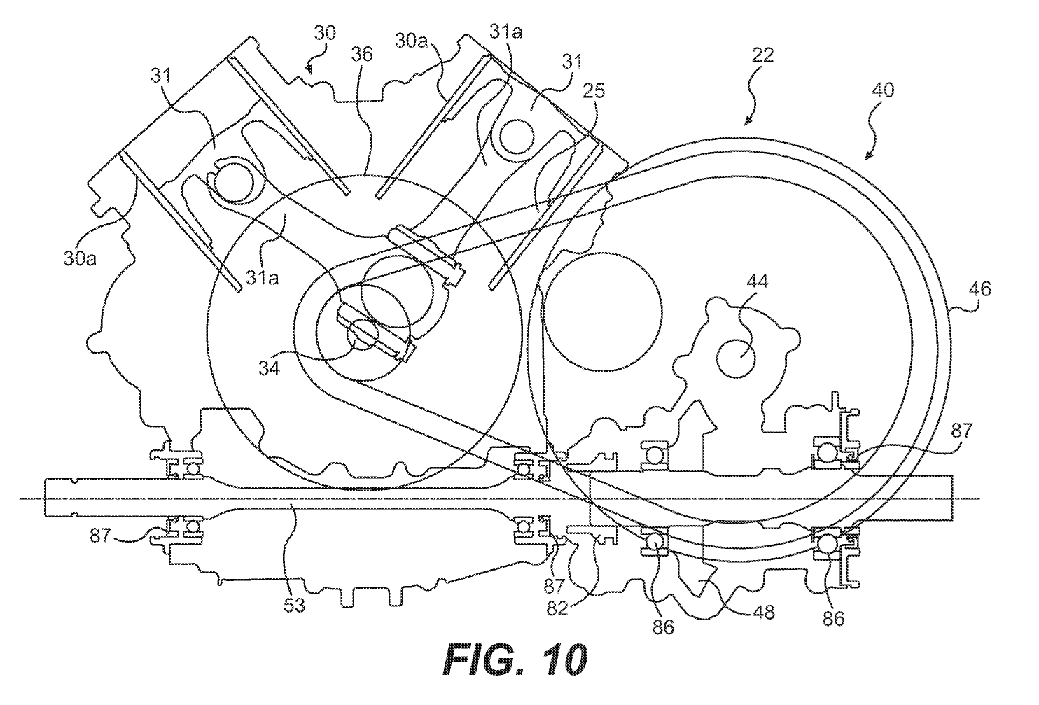

FIG. 10 is a schematic side view of the drivetrain in accordance with another embodiment of the present invention. This embodiment is similar to the embodiment shown in FIG. 7, but differs from it in that the diameter of the driven pulley 46 of the CVT 22 is larger than the diameter of the drive pulley 36. Thus, the transmission ratio between the drive pulley 36 and the driven pulley 46 is different than in the embodiment of FIG. 7, which results in a different vehicle performance.

Persons of ordinary skill in the art will appreciate that variations or modifications may be made to the drivetrain of the all-terrain vehicle disclosed in the specification and drawings without departing from the spirit and scope of the invention. Furthermore, persons of ordinary skill in the art will appreciate that the drivetrain described and illustrated merely represents the best mode of implementing the invention known to the Applicant; however, it should be understood that other mechanisms or configurations, using similar or different components, can be used to implement the present invention. Therefore, the embodiments of the invention described above are only intended to be exemplary. The scope of the invention is limited solely by the claims.

What is claimed is:

1. A wheeled vehicle comprising:
a frame;
a straddle seat mounted on the frame for supporting a driver;
a plurality of wheels suspended from the frame, each wheel having a tire;
a steering assembly disposed on the frame forwardly of the straddle seat for steering at least one of the plurality of wheels;
an engine mounted to the frame, the engine having an engine casing and a crankshaft;
a transmission being driven by the crankshaft, the transmission being disposed outside of the engine casing;
a drive shaft passing through the engine casing, the drive shaft being driven by the transmission and being separate from the crankshaft; and
a differential being driven by the drive shaft, the drive shaft driving at least one of the plurality of wheels via the differential.

2. The vehicle as claimed in claim 1, wherein the transmission is disposed rearwardly of the engine, the drive shaft is a front drive shaft, the differential is a front differential, and the plurality of wheels includes two front wheels, wherein the front drive shaft drives the two front wheels via the front differential.

3. The vehicle as claimed in claim 2, wherein the transmission is detachably connected to a rear portion of the engine casing.

4. The vehicle as claimed in claim 3, wherein the transmission comprises a mounting flange for detachably connecting the transmission to the engine casing, the mounting flange comprising a bore through which the front drive shaft passes.

5. The vehicle as claimed in claim 1, wherein the engine further comprises an oil pan disposed at a bottom portion of the engine, wherein the drive shaft passes through the engine casing above an oil level in the oil pan.

6. The vehicle as claimed in claim 2, wherein the engine further comprises an oil pan disposed at a bottom portion of the engine, wherein the front drive shaft passes through the engine casing above an oil level in the oil pan.

7. The vehicle as claimed in claim 1, wherein the crankshaft comprises a pair of counterweights for a piston of the engine to facilitate reciprocation of the piston, wherein the drive shaft passes between the pair of counterweights.

8. The vehicle as claimed in claim 2, wherein the crankshaft comprises a pair of counterweights for a piston of the engine to facilitate reciprocation of the piston, wherein the front drive shaft passes between the pair of counterweights.

9. The vehicle as claimed in claim 1, wherein the drive shaft is parallel to a central longitudinal axis of the vehicle and perpendicular to the crankshaft.

10. The vehicle as claimed in claim 2, further comprising:
a rear drive shaft being driven by the transmission; and
a rear differential being driven by the rear drive shaft,
wherein the front differential, the front drive shaft, the rear drive shaft, and the rear differential are in coaxial alignment and define an axis parallel to a central longitudinal axis of the vehicle.

11. The vehicle as claimed in claim 1, wherein the transmission is disposed forwardly of the engine casing, the drive shaft is a rear drive shaft, the differential is a rear differential, and the plurality of wheels includes two rear wheels, wherein the rear drive shaft drives the two rear wheel via the rear differential.

12. The vehicle as claimed in claim 12, wherein the transmission is detachably connected to a forward portion of the engine casing.

13. The vehicle as claimed in claim 13, wherein the transmission comprises a mounting flange for detachably connecting the transmission to the engine casing, the mounting flange comprising a bore through which the rear drive shaft passes.

14. The vehicle as claimed in claim 11, wherein the engine further comprises an oil pan disposed at a bottom portion of the engine, wherein the rear drive shaft passes through the engine casing above an oil level in the oil pan.

15. The vehicle as claimed in claim 11, wherein the crankshaft comprises a pair of counterweights for a piston of the engine to facilitate reciprocation of the piston, wherein the rear drive shaft passes between the pair of counterweights.

16. The vehicle as claimed in claim 11, wherein the rear drive shaft is parallel to a central longitudinal axis of the vehicle and perpendicular to the crankshaft.

17. The vehicle as claimed in claim 1, wherein the crankshaft drives the transmission via a continuously variable transmission.

18. The vehicle as claimed in claim 2, wherein the crankshaft drives the transmission via a continuously variable transmission.

19. A wheeled vehicle comprising:
a frame;
a straddle seat mounted on the frame for supporting a driver;
a plurality of wheels suspended from the frame, each wheel having a tire;
a steering assembly disposed on the frame forwardly of the straddle seat for steering at least one of the plurality of wheels;
an engine mounted to the frame, the engine having an engine casing and a crankshaft;
means for transmitting power being driven by the crankshaft, the means for transmitting power being disposed outside of the engine casing;
means for driving at least one of the wheels passing through the engine casing, the means for driving being driven by the means for transmitting power and being separate from the crankshaft; and
a differential being driven by the means for driving, the means for driving driving at least one of the plurality of wheels via the differential.

20. A wheeled vehicle comprising:
a frame;
a straddle seat mounted on the frame for supporting a driver;
a plurality of wheels suspended from the frame, each wheel having a tire;
a steering assembly disposed on the frame forwardly of the straddle seat for steering at least one of the plurality of wheels;
an engine mounted to the frame, the engine having an engine casing and a crankshaft; and
a drivetrain comprising:
a transmission operatively interconnecting the crankshaft with one of the wheels; and
a plurality of shafts, at least one of the plurality of shafts passing through the engine.
